(19) United States
(12) Patent Application Publication
(10) Pub. No.: US 2008/0106087 A1
(43) Pub. Date: May 8, 2008

(54) Year book storage system

(76) Inventor: Lisa Surowitz, Williamsburg, MI (US)

Correspondence Address: JAMES RAY & ASSOCIATES, 2640 PITCAIRN ROAD, MONROEVILLE, PA, 15146, US

(21) Appl. No.: 11/977,256

(22) Filed: Oct. 24, 2007

Related U.S. Application Data
(60) Provisional application No. 60/862,796, filed on Oct. 25, 2006.

(51) Int. Cl. B42D 17/00

(52) U.S. Cl. 281/49

(57) ABSTRACT

A binder system for holding of bound documents that includes a bracket and hinge that are releasably attached to each other to define a bracket hinge assembly. The bracket and hinge assembly holds the bound document and is attached to a binder. The bracket is inserted in the bound volume and end portions of the bracket are inserted and secured in slots in the hinge. The hinge has apertures to permit the insertion of ribbons, rings or posts to hold the bound document in the binder.

### CROSS REFERENCE TO RELATED APPLICATION

This patent application is related to and claims priority from U.S. Provisional Patent Application Ser. No. 60/862,796 filed Oct. 25, 2006.

### FIELD OF THE INVENTION

The present invention relates, in general, to document storage and, more particularly, this invention relates to a system of storage of multiple bound volumes of publications.

### BACKGROUND OF THE INVENTION

Prior to the conception and development of the present invention, as is generally well known in the prior art, storage of bound volumes relied on clips, perforated apertures and the like. Other art show the use of hangers holding publications in place by gravity. Such devices did not permit the simple removal of the printed volumes from the holder, The other devices were for use with ribbons, rings or posts to attach the volumes to the binder, but not adapted for use of any of these attachment methods.

### SUMMARY OF THE INVENTION

The present invention provides a system to securely hold bound volumes in a binder. One or more volumes can be he placed in a binder, such as yearbooks. Each volume has a bracket that is inserted within the pages of the bound volume. The bracket mates with a hinge member. The hinge member has apertures and is attached to the binder by threading a ribbon through the aperture in the hinge member or by use of binder rings or posts.

The bracket has a longitudinal axis and opposing end portions. The hinge has slots that securely engage the end portions of the bracket. The end portions preferably have a dimple that mates with a substantially similar shaped, positioned and sized dimple with which it mates with a similar dimple within the slots. The dimples are a detent that positions the parts and holds the parts. The detent can be overcome with which can overcome with greater than the insertion force and is therefore releasable. Another embodiment is a flange perpendicular to the end portion of the bracket engages with a spring-tensioned catch within the slot of the hinge. A button through the surface of the hinge actuates the catch release.

The hinge is attached to the binder with ribbons, rings or posts. The hinge has apertures sized and shaped to accommodate either ribbons or posts, or apertures with a keyhole shape to accommodate ribbons, posts or rings.

### OBJECTS OF THE INVENTION

It is, therefore, one of the primary objects of the present invention to releasably secure bound volumes in a binder.

Another object of the present invention is to provide a device to secure bound volumes to a hinge member removable from a binder.

Still another object of the present invention is to provide a hinge and bracket assembly that is holds a bound volume.

Yet another object of the present invention is to provide a hinge and bracket assembly that is securely mates to hold a bound volume.

An additional object of the present invention is to provide a hinge and bracket assembly wherein the bracket is releasable.

Another object is to provide a hinge that can be attached to a binder with ribbon, rings or posts.

Another object is providing a binder system that holds a plurality of bound volumes.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a plan view of a hinge.

FIG. 2 is a plan view of a bracket.

FIG. 3 is a perspective view showing a volume with bracket unassembled into the hinge.

FIG. 4 is a perspective view of the volume with the bracket and hinge assembled.

FIG. 5 is a perspective view of the volume, bracket, hinge and ribbon assembly.

FIG. 6 is a plan view of second embodiment of a hinge.

FIG. 7 is a plan view of a third embodiment of a hinge.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components that have identical functions have been identified with identical reference numerals throughout the several views illustrated in the drawing figures.

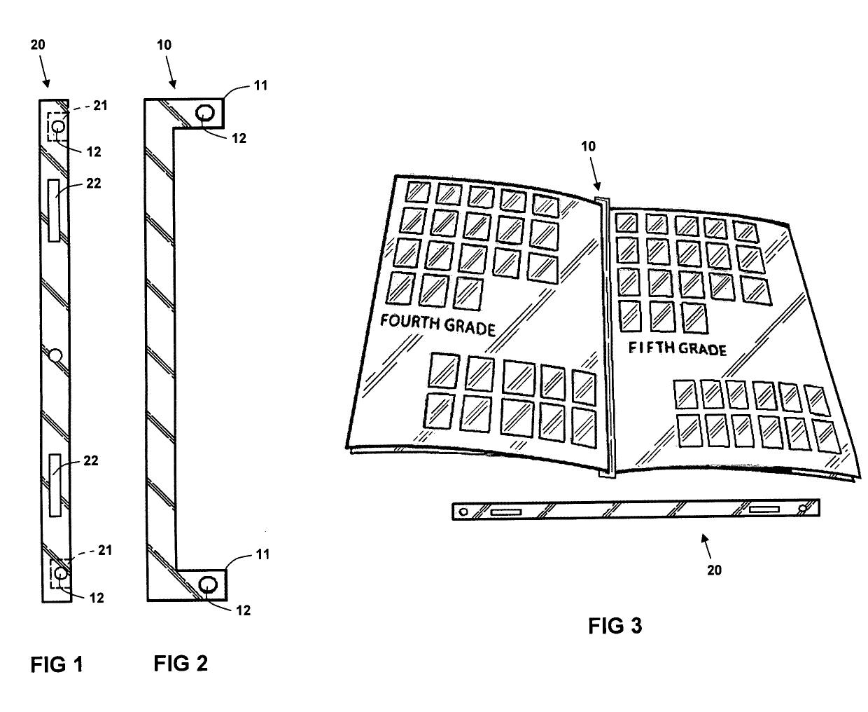

Reference is now made, more particularly, to FIGS. 1 and 2 a bracket 10 having a longitudinal axis and opposing end portions 11. In the preferred embodiment, the predetermined length of the bracket along the longitudinal axis is 11 inches. The bracket 10 is placed within a bound publication such as a book. The bracket 10 length is greater than the height of said book so that the end portions 11 extend beyond the books spine. Hinge portion 20 has a length greater than the height of the bound publication to be store in a binder and greater then the distance between the end portions of said bracket 10. In the preferred embodiment, the length along the longitudinal axis is 11 3/16 inches. Said hinge member has two slots 21 within the side of said hinge portion. Said slot portions positioned a distance from the end of said hinge 20 so as to accommodate said opposing end portions 11 of said bracket 10.

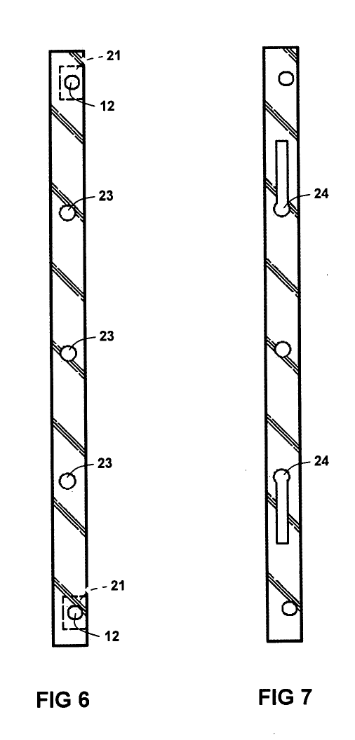

Said hinge 20 has apertures 22 with a predetermined shape, position and size. In the preferred embodiment, the apertures are rectangular with a length of ¼ inch and a width of ⅛ inch. Another embodiment is shown in FIG. 6 with round apertures 23 that can accommodate rings or posts from a binder. A third embodiment shown in FIG. 7 shows a combination aperture that can accommodate ribbons or binder rings and posts. The number of apertures 24 in said hinge 20 is at least 2, but could be up to 6.

Each opposing end member 11 has a element to releasably secure said end portion within said slots. In the preferred embodiment, said element is a dimple 12 formed on said end portions 11 and a dimple within each of said slots 21.

An alternative embodiment (not shown) is a flange formed in each of said end portions 11 with a spring tensioned release catch within each of said slots 21. A button through a surface of hinge 20 actuates the release catch for each of said catches.

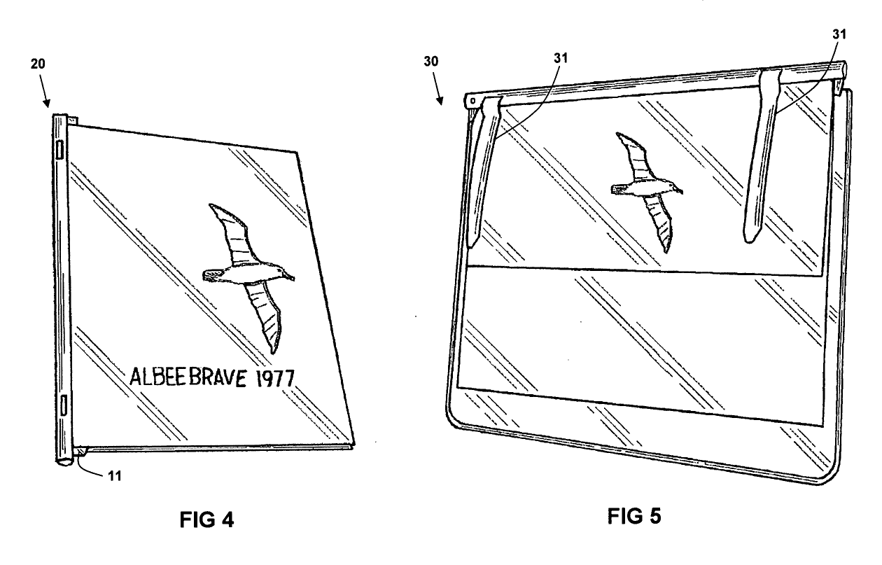

The bracket 10 and hinge 20 are assembled as shown in FIG. 3 and FIG. 4. Said bracket 10 end is placed within the bound publication. Said end portions 11 are inserted into slots 21 of hinge 20.

The assembled bracket 10 and hinge 20 are placed into a binder as shown in FIG. 5. The preferred embodiment a ribbon 31 threaded through apertures 22 to bind the hinge 20 and bracket 10 assemblies to the binder 30. The other embodiments of the aperture 23 and 24 are placed in the binder using posts or rings (not shown).

The bracket 10 and hinge 20 assembly are easily disassembled to replace volumes within the binder or temporarily use the volumes.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A binder system for storing bound volumes comprising:
at least one bracket with a longitudinal axis having a predetermined length width and depth, and opposing end portions at substantially right angles to said longitudinal axis, said opposing end portions having a predetermined length, width and said end portions having a means to attach said bracket to a hinge member, said bracket is inserted said volume;
at least one hinge member having a longitudinal axis with opposing ends and with a predetermined height length and width, said hinge member having at least two apertures with a predetermined shape size and predetermined distance from said opposing ends said hinge member having a slot having a predetermined width larger than the depth of said bracket and a length greater than the width of said opposing end of said bracket, said slot having a means to releasably securely engage said opposing end portions of said bracket within said slot;
a means for attaching said hinge member to such binder through said apertures.

2. A binder system of claim 1 where in said means of attaching said bracket to said hinge and said means to releasably securely engage said opposing end portions of said bracket is a detent mating said bracket and said hinge wherein said detent may be released by increased force.

3. A binder system of claim 1 wherein said opposing bracket end portions further comprises
at least one flange for each end portion of said end portion of said hinge, said flange forms a substantially right angle to said end portion of said hinge; and
said slot having a spring tensioned releasable catch actuated by a button through the upper surface of said hinge.

4. A binder system of claim 1 wherein said predetermined shape of said hinge apertures is substantially a rectangular with a predetermined length and width, said means for attaching said hinge to said binder is a ribbon attached to said binder and thread through said at least one hinge.

5. A binder system of claim 1 wherein said predetermined shape of said hinge apertures is substantially circular and said means for attaching said hinge to said binder are among a group of rings and posts.

6. A binder system of claim 1 wherein said predetermined shape of said hinge apertures is a combination rectangle and circle shaped.

7. A binder system of claim 6 where in said means for attaching said hinge to said binder is a ribbon.

8. A binder system of claim 6 wherein said means for attaching said hinge to said binder is among a group of rings and posts.

9. A binder system of claim 1 where in the number of apertures is among a group of 2, 3, 6 and 7.

10. An assembly to secure bound volumes:
a bracket with a longitudinal axis having a predetermined length width and depth, said predetermined length greater than the length of such volume, and opposing end portions at substantially right angles to said longitudinal axis, said opposing end portions having a predetermined length, width and said end portions having a means to attach said bracket to a hinge member, said bracket is inserted such volume;
a hinge member having a longitudinal axis with opposing ends and with a predetermined height length and width, said hinge member having at least two apertures with a predetermined shape size and predetermined distance from said opposing ends said hinge member having a slot having a predetermined width larger than the depth of said bracket and a length greater than the width of said opposing end of said bracket, said slot having a means to releasably securely engage said opposing end portions of said bracket within said slot.

11. A binder system of claim 10 wherein said opposing bracket end portions further comprises
at least one flange for each end portion of said end portion of said hinge, said flange forms a substantially right angle to said end portion of said hinge; and
said slot having a spring tensioned releasable catch actuated by a button through the upper surface of said hinge.

12. A binder system of claim 10 wherein said predetermined shape of said hinge apertures is substantially a rectangular with a predetermined length and width,

13. A binder system of claim 10 wherein said predetermined shape of said hinge apertures in said hinge are substantially circular.

14. A binder system of claim 10 wherein said predetermined shape of said hinge apertures is a combination rectangle and circle shaped.

15. A binder system of claim 10 where in the number of apertures is among a group of 2, 3, 6 and 7.
